(19) United States
(12) Patent Application Publication
(10) Pub. No.: US 2007/0054638 A1
(43) Pub. Date: Mar. 8, 2007

(54) Apparatus and method to control audio volume in D class amplifier

(75) Inventor: Young-suk Song, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/501,685

(22) Filed: Aug. 10, 2006

(30) Foreign Application Priority Data
Sep. 6, 2005 (KR) 2005-82627

(51) Int. Cl. H04B 1/16

(52) U.S. Cl. 455/205

(57) ABSTRACT

An apparatus and method to control audio volume through adjustment of a carrier level in a D class amplifier. The apparatus includes a control unit to generate a volume control signal, a PWM unit to adjust the level of a carrier signal according to the volume control signal generated by the control unit and to generate a pulse width modulation signal by comparing the adjusted carrier signal level with the level of an input audio signal, generating; and a power amplification unit to amplify the power of the pulse width modulation signal generated by the PWM unit.

### CROSS-REFERENCE TO RELATED APPLICATIONS

This application claims the benefit of Korean Patent Application No.10-2005-0082627, filed on Sep. 6, 2005, in the Korean Intellectual Property Office, the disclosure of which is incorporated herein in its entirety by reference.

### BACKGROUND OF THE INVENTION

1. Field of the Invention

The present general inventive concept relates to a D class amplifier, and more particularly, to an apparatus and method to control audio volume through adjustment of a carrier level in a D class amplifier.

2. Description of the Related Art

In general, A, B, AB, and D class amplifiers are used as power amplifiers for an audio system. Among these amplifiers, the D class amplifier can reduce the amplification efficiency degradation occurring in A, B, and AB class amplifiers. The D class amplifier uses a switching method after converting an audio signal into a pulse width modulation (PWM) signal. Accordingly, if the D class amplifier has no data conversion loss, and a nonlinear component problem occurring in an analog part beginning from the switching circuit is solved, the D class amplifier can have 100% amplification efficiency, theoretically. Generally, an audio system employing this D class amplifier includes a microcomputer controlling the entire system, a digital signal processor performing digital signal processing, a PWM unit generating a PWM signal by comparing an audio signal with a carrier signal, and a power amplifier amplifying power of the PWM signal and current.

The digital signal processor, if it receives an input of a volume level control signal from the microcomputer, changes gains of the audio data to fit the volume level. At this time, if the volume level is adjusted to be equal to or greater than a predetermined level, the least significant bit (LSB) part of the audio data becomes damaged by an operation, such as a shift operation. For example, if 8-bit input audio data “1111 1111” is shifted to “0111 1111” through digital gain adjustment, the LSB part is lost. As another example, when the gain value of audio data is −12 dB, it is assumed that audio data A is “0010 1111” and audio data B is “0010 1100.” At this time, if the gain values of the audio data are lowered by 12 dB, the audio data A becomes “0000 1011” and audio data B becomes “0000 1011,” and both the audio data A and the audio data B have the same value. In other words, before the adjustment of the audio data gains, audio data A and B were different signals, but after the adjustment of the audio data gains, the audio data A and B have identical sample values and the original audio information is lost.

Accordingly, since the digital gain adjustment method of the conventional D class amplifier frequently causes loss of a substantial amount of LSB parts of audio data, the accuracy of sound from the audio data is lowered, and accordingly, the naturalness of the sound is decreased.

### SUMMARY OF THE INVENTION

The present general inventive concept provides an audio volume control apparatus and method capable of preventing degradation of sound quality by adjusting volume through adjustment of a carrier signal level in a PWM converter in an audio system using a D class digital amplifier.

The present general inventive concept also provides an audio volume control apparatus and method capable of preventing degradation of sound quality by adjusting audio volume through linking the digital volume in a digital signal processor and the carrier signal level in a PWM converter in an audio system using a D class digital amplifier.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a digital audio amplifier including: a control unit to generate a volume control signal; a pulse width modulation unit to adjust a level of a carrier signal according to the volume control signal generated by the control unit and to generate a pulse width modulation signal by comparing the adjusted carrier signal level with the level of an input audio signal; and a power amplification unit to amplify the power of the pulse width modulation signal generated by the power pulse width modulation unit.

The foregoing and/or other aspects and utilities of the present general inventive concept are also achieved by providing a digital audio amplification system including: a signal processing unit to adjust a level of an input audio signal according to a volume control signal; a pulse width modulation unit to adjust a level of a carrier signal according to the volume control signal and to generate a pulse width modulation signal by comparing the adjusted carrier signal level with the level of the audio signal adjusted in the signal processing unit; a control unit to generate a volume control signal to adjust audio volume by linking the gain of the audio signal and the level of the carrier signal according to the volume level range; and a power amplification unit to amplify the power of the pulse width modulation signal generated by the power pulse width modulation unit.

The foregoing and/or other aspects and utilities of the present general inventive concept are also achieved by providing a method of controlling volume of a digital audio amplifier having a signal processor to adjust the gain of an audio signal and a pulse with modulation unit to generate a pulse width modulation signal by comparing a carrier signal and an audio signal, the method including: receiving an input of an arbitrary audio volume level; and according to the input audio volume level, adjusting audio volume by linking the gain of the audio signal and the level of the carrier signal.

The foregoing and/or other aspects and utilities of the present general inventive concept are also achieved by providing a method of applying audio volume control to an audio reproduction system, the method including adjusting a gain of an audio signal when a volume level is lower than a predetermined reference value, and adjusting a level of a carrier signal when the volume level is equal to or greater than the predetermined reference level.

The foregoing and/or other aspects and utilities of the present general inventive concept are also achieved by providing a computer readable medium containing a method of controlling volume of a digital audio amplifier having a signal processor to adjust a gain of an audio signal and a pulse with modulation unit to generate a pulse width modulation signal by comparing a carrier signal and an audio signal, the method including receiving an input of an arbitrary volume level of an audio signal; and according to the input audio volume level, adjusting audio volume by linking the gain of the audio signal and the level of the carrier signal.

The foregoing and/or other aspects and utilities of the present general inventive concept are also achieved by providing a computer readable medium containing a method of applying audio volume control to an audio reproduction system, the method including adjusting a gain of an audio signal when a volume level is lower than a predetermined reference value; and adjusting a level of a carrier signal when the volume level is equal to or greater than the predetermined reference level.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an apparatus to control audio volume of a D class amplifier according to an embodiment of the present general inventive concept;

FIG. 2 is an embodiment of a PWM unit of FIG. 1, according to the present general inventive concept;

FIG. 3 is f a power amplification unit of FIG. 1, according to an embodiment of the present general inventive concept;

FIG. 4 illustrates waveforms showing volume control of a PWM unit of FIG. 1, according to an embodiment of the present general inventive concept;

FIG. 5 illustrates an example of applying audio volume control according to an embodiment of the present general inventive concept, to an audio reproduction system; and

FIG. 6 is a flowchart of a method of controlling audio volume in a D class amplifier according to an embodiment of the present general inventive concept.

### DETAILED DESCRIPTION OF THE PREFERRED EMBODIMENTS

The present invention will now be described more fully with reference to the accompanying drawings, in which exemplary embodiments of the invention are shown.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 is a block diagram of an apparatus to control audio volume of a D class amplifier, according to an embodiment of the present general inventive concept.

The apparatus of FIG. 1 to control audio volume of a D class amplifier includes a micom unit 110, a digital signal processor (DSP) unit 120, a digital analog converter (DAC) unit 130, a pulse width modulation (PWM) unit 140, a power amplification unit 150, and a speaker 160.

If a volume level is input to the apparatus of FIG. 1 by a remote controller or the like, the micom unit 110 converts the volume level into a corresponding volume control signal. At this time, the micom unit 110 outputs the volume control signal selectively to the DSP unit 120 or the PWM unit 140 according to the volume level value. For example, if the volume level value is equal to or greater than a reference value (for example, “10”), the PWM unit 140 is made to adjust a carrier signal level. In contrast, if the volume level value is less than the reference value, an audio signal level is lowered to the reference volume level by adjusting the carrier signal level in the PWM unit 140, and then the volume level is controlled in the DSP unit 120 within a range corresponding to the magnitude obtained by subtracting the input volume level from the reference volume level.

The DSP unit 120 performs signal processing of an input audio signal, such as decoding algorithm processing, equalizing, and enhancement, according to the volume control signal provided by the micom unit 110. In particular, the DSP unit 120 adjusts a gain of a digital audio signal input according to the volume control signal occurring in the micom unit 110.

The DAC unit 130 converts the digital audio signal in which the gain is adjusted in the DSP unit 120, into an analog audio signal.

The PWM unit 140 adjusts the level of a carrier signal according to the volume control signal occurring in the micom unit 110, and generates a low power PWM signal by comparing the carrier signal level with the level of the audio signal output from the DSP unit 120.

The power amplification unit 150 amplifies the power of the PWM signal generated in the PWM unit 140 through a switching circuit. After noise in the power amplified PWM signal is removed through a low pass filter, the PWM signal is input to the speaker 160.

The speaker 160 reproduces sound with the PWM signal amplified in the power amplification unit 150.

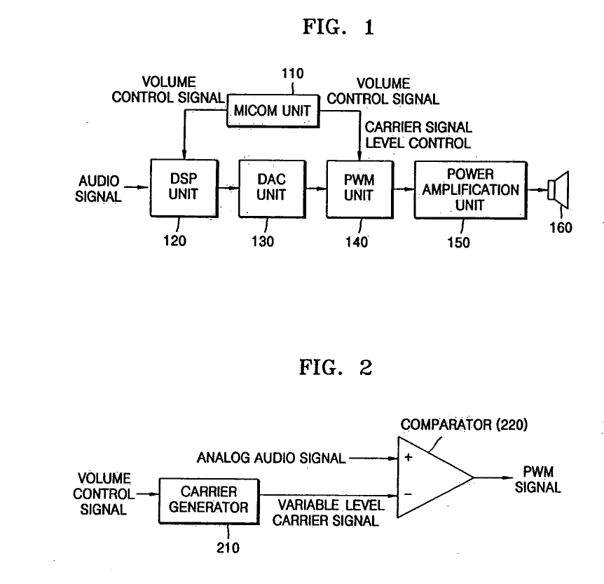

FIG. 2 is an exemplary embodiment of the PWM unit 140 of FIG. 1, according to an embodiment of the present general inventive concept.

In the PWM unit of FIG. 2, a carrier generator 210 generates a carrier signal, and the level of the carrier signal is adjusted according to a volume control signal input from the micom unit 110. In an exemplary embodiment, the level of the carrier signal can be adjusted by using an operational (OP) amplifier.

The comparator 220 compares the level of the carrier signal generated in the carrier generation unit 210 with a level of an analog audio signal input from the DAC unit 130 and generates a PWM signal based on the comparison. At this time, the comparator 220 compares the analog audio signal with the carrier signal, and if the analog audio signal level is greater than the carrier signal level, the comparator 220 outputs a high logic level, and if the audio signal level is less than the carrier signal level, the comparator 220 outputs a low logic level.

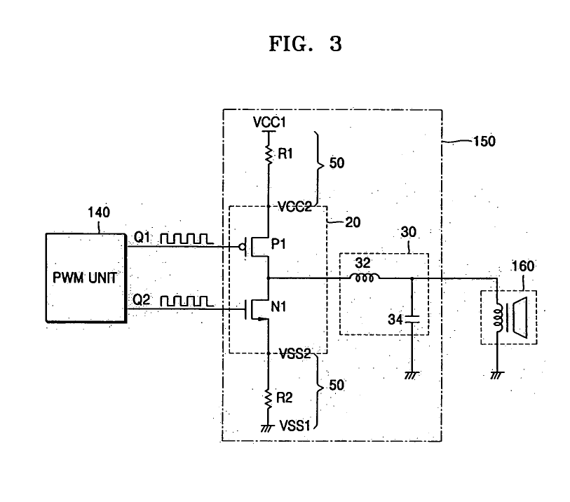

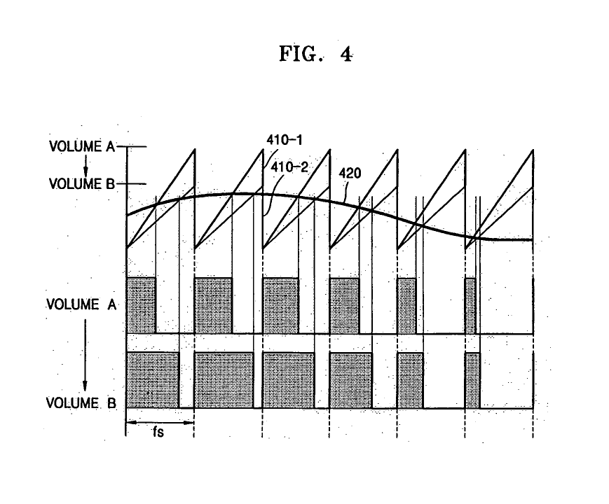

FIG. 3 is an exemplary embodiment of the power amplification unit 150 of FIG. 1, according to an embodiment of the present general inventive concept.

The power amplification unit 150 of FIG. 3 includes a power switching unit 20 and a low pass filter 30.

The power switching unit 20 includes a PMOS transistor P1 and an NMOS transistor N1. The PMOS transistor P1 is switched according to a first output signal Q1 of the PWM unit 140, and an actual voltage Vcc2 is applied to the source of the PMOS transistor P1. The NMOS transistor N1 is also switched according to a second output signal Q2 of the PWM unit 140, the drain of the NMOS transistor N1 is connected to the drain of the PMOS transistor P1, and the source of the NMOS transistor N1 is connected to a ground voltage Vss2. Here, Vcc1 and Vss1 are ideal voltages applied from a power source, and the Vcc2 and a Vss2 are actual voltages dropped by predetermined levels by resistances R1 and R2 in the wire connecting the power source and the power switching unit 20, and are applied to the power switching unit 20. Also, R1 and R2 are resistances occurring in the conducting wire connecting the power source and the power switching unit 20.

The low pass filter 30 can include an inductor 32 and a capacitor 34, and removes a high frequency component in an output signal of the power switching unit 20.

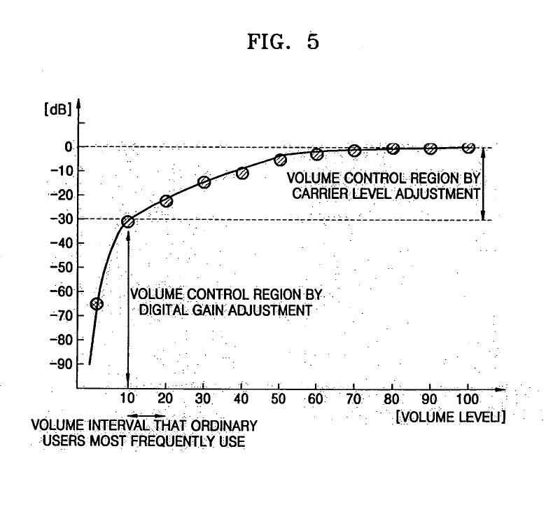

FIG. 4 illustrates waveforms of volume control of the PWM unit 140 of FIG. 1, according to an embodiment of the present general inventive concept.

The carrier signal level 410-1 or 410-2 generated in the carrier generation unit 210 is compared with the level of the analog audio signal input from the DAC unit 130, and then a PWM signal is generated from this comparison. At this time, when the audio signal and the carrier signal are compared, if the audio signal level is determined to be greater than the carrier signal level, a high logic level is output, and if the audio signal level is determined to be less than the carrier signal level, a low logic level is output. Also, the period of the carrier signal is the same as a sampling frequency (fs) of the audio signal. When volume of the audio signal is increased from volume A to volume B, the carrier signal is lowered from A level 410-1 to B level 410-2 according to the volume control signal applied by the micom unit 110. Accordingly, the pulse width of volume B (of the audio signal) becomes wider than the pulse width of the volume A (of the audio signal) such that audio volume is increased. At this time, the magnitude of the carrier signal should not be less than that of the input audio signal in order to prevent saturation. Therefore, since the present general inventive concept adjusts only the level of the carrier signal without changing the audio signal level, the original audio signal is not damaged.

FIG. 5 illustrates applying audio volume control to an audio reproduction system, according to an exemplary embodiment of the present general inventive concept.

Referring to FIG. 5, when a volume level is determined to be less than a reference value, for example 10, in FIG. 5, the volume is controlled by adjusting a gain of the audio signal. That is, when the volume level is less than the reference value 10, the magnitude of the audio signal should be lowered to a value equal to or less than about −35 dB. However, when the volume is controlled in the PWM unit 140, the magnitude of the carrier signal corresponding to a value of the audio signal equal to or less than −35 dB is too large. Accordingly, since there is a limit in increasing the magnitude of the carrier signal, the micom unit 110 provides a volume control signal to the DSP unit 120 so that the volume can be controlled by adjusting the gain of the audio signal. Also, when the volume level is equal to or greater than the exemplary reference value 10, controlling the volume in the PWM unit 140 is more effective. Accordingly, when the volume level is equal to or greater than the exemplary reference value 10, the micom unit 110 provides a volume control signal to the PWM unit 140 so that the volume can be controlled by adjusting the level of the carrier signal. At this time, only up to the situation where the magnitude of the carrier signal is greater than the magnitude of the audio signal is considered. Also, when the volume level that users use most frequently is approximately between 10-20, the micom unit 110 outputs a volume control signal to the PWM unit 140.

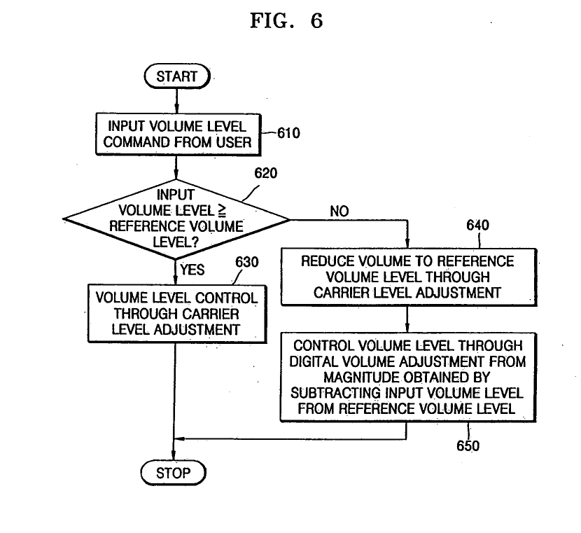

FIG. 6 is a flowchart of a method of controlling audio volume in a D class amplifier, according to an embodiment of the present general inventive concept.

First, a volume level command from a user is input in operation 610.

Then, the input volume level is compared with a preset reference volume level in operation 620. Here, the reference volume level refers to the maximum value of the volume level that can be controlled by a carrier level adjusting method, and this value may vary depending on an audio system to which the method is applied.

At this time, if the input volume level is equal to or greater than the reference volume level, volume level control by carrier level adjustment is performed in operation 630.

However, if the input volume level is less than the reference volume level, an audio signal level is lowered to the reference volume level by using the carrier level adjustment in operation 640.

Then, the volume level is controlled by the digital volume adjustment (gain adjustment of the audio signal) within a range corresponding to the magnitude obtained by subtracting the input volume level from the reference volume level in operation 650. For example, if the input volume level is “5” and the reference volume level is “10,” by using the carrier level adjustment, the volume level is lowered to the reference volume level “10.” Then, the volume level is controlled by the digital volume adjustment for “5” corresponding to the magnitude obtained by subtracting the input volume level from the reference volume level.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present general inventive concept as described above, in an audio system using a D class digital amplifier, such as a TV and a home theater system, volume adjustment is performed by adjusting the level of a carrier signal in the PWM converter without changing the level of an audio signal, such that degradation of sound quality can be prevented.

According to the present general inventive concept as described above, audio volume control can be applied to an audio reproduction system by adjusting a gain of an audio signal when a volume level is lower than a predetermined reference value and adjusting a level of a carrier signal when the volume level is equal to or greater than the predetermined reference level.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A digital audio amplifier comprising:
a control unit to generate a volume control signal from an input volume level of an audio signal;
a pulse width modulation (PWM) unit to adjust a level of a carrier signal according to the volume control signal generated by the control unit and to generate a pulse width modulation signal by comparing the adjusted carrier signal level with the level of the input audio signal; and
a power amplification unit to amplify a power of the pulse width modulation signal generated by the power pulse width modulation unit.

2. The amplifier of claim 1, wherein the pulse width modulation unit comprises:
a carrier generation unit to generate a carrier signal whose level is adjusted according to the volume control signal; and
a comparison unit to generate a pulse width modulation signal by comparing the level of the carrier signal generated in the carrier generation unit and the level of an input audio signal.

3. The amplifier of claim 1, wherein the power amplification unit amplifies the power of the PWM unit through a switching circuit.

4. The amplifier of claim 2, wherein the carrier signal is adjusted by an operational (OP) amplifier.

5. The amplifier of claim 1, wherein the power amplification unit comprises a power switching unit and a low pass filter.

6. The amplifier of claim 5, wherein the power switching unit comprises a PMOS transistor and an NMOS transistor.

7. A digital audio amplification system comprising:
a signal processing unit to adjust a level of an input audio signal according to a volume control signal;
a pulse width modulation unit to adjust a level of a carrier signal according to the volume control signal and to generate a pulse width modulation signal by comparing the adjusted carrier signal level with the level of the audio signal adjusted in the signal processing unit;
a control unit to generate a volume control signal to adjust audio volume by linking the gain of the audio signal and the level of the carrier signal according to the volume level range; and
a power amplification unit to amplify the power of the pulse width modulation signal generated by the power pulse width modulation unit.

8. The system of claim 7, wherein if an input volume level value is equal to or greater than a reference value, the control unit adjusts the carrier signal level of the pulse width modulation unit, and if the input volume level value is less than the reference value, the control unit adjusts audio volume by linking the carrier signal level adjustment of the pulse width modulation unit and the gain adjustment of an audio signal of the signal processing unit.

9. The system of claim 8, wherein the reference value is a maximum volume level in which volume is controlled through the level adjustment of the carrier signal.

10. The system of claim 7, wherein the power amplification unit comprises:
a power switching unit to amplify power of the pulse with modulation signal generated in the pulse width modulation unit; and
a low pass filter to remove the high frequency component of a signal output from the power switching unit.

11. A method of controlling volume of a digital audio amplifier having a signal processor to adjust a gain of an audio signal and a pulse with modulation unit to generate a pulse width modulation signal by comparing a carrier signal and an audio signal, the method comprising:
receiving an input of an arbitrary volume level of an audio signal; and
according to the input audio volume level, adjusting audio volume by linking the gain of the audio signal and the level of the carrier signal.

12. The method of claim 11, wherein in the adjusting of the audio signal volume, if an input volume level is equal to or greater than a reference value, the level of the carrier signal is adjusted, and if the input volume level is less than the reference value, the gain of the audio signal is adjusted for a magnitude obtained by subtracting the input volume level from a reference volume level.

13. The method of claim 12, wherein the reference value is a maximum volume level value in which volume is controlled through the level adjustment of the carrier signal.

14. A method of applying audio volume control to an audio reproduction system, the method comprising:
adjusting a gain of an audio signal when a volume level is lower than a predetermined reference value; and
adjusting a level of a carrier signal when the volume level is equal to or greater than the predetermined reference level.

15. The method of claim 14, wherein the adjusting of the level of the carrier signal comprises providing a volume control signal to a pulse width modulation unit, which adjusts the level of the carrier signal.

16. A computer readable medium containing a method of controlling volume of a digital audio amplifier having a signal processor to adjust a gain of an audio signal and a pulse with modulation unit to generate a pulse width modulation signal by comparing a carrier signal and an audio signal, the method comprising:
receiving an input of an arbitrary volume level of an audio signal; and
according to the input audio volume level, adjusting audio volume by linking the gain of the audio signal and the level of the carrier signal.

17. A computer readable medium containing a method of applying audio volume control to an audio reproduction system, the method comprising:
adjusting a gain of an audio signal when a volume level is lower than a predetermined reference value; and
adjusting a level of a carrier signal when the volume level is equal to or greater than the predetermined reference level.
